(19) United States
(12) Patent Application Publication
(10) Pub. No.: US 2003/0038217 A1
(43) Pub. Date: Feb. 27, 2003

(54) Adjustable support strap for pipes and the like

(76) Inventors: James Michael Rivers, Marrow, GA (US); Ahmed A. Elnoor, Jamacia, NY (US)

Correspondence Address: Harry I. Leon, 924 Bowen St., N.W., Atlanta, GA, 30318, US

(21) Appl. No.: 09/934,206

(22) Filed: Aug. 22, 2001

(51) Int. Cl. F16L 3/08

(52) U.S. Cl. 248/74.1; 248/70

(57) ABSTRACT

An adjustable pipe strap useful for both a range of pipe sizes and for pipes mounted at a range of distances from a support surface. Formed or forged, cast or fabricated of sheet metal or molded plastic, four structural members are held in assembled relation by three bolts in this strap. The bolts also allow the strap to expand or contract in size. Arcuate sections of two of the structural members, which are mirror images of one another, terminate in flanges whose contiguous faces in the assembled strap are held in position, but typically not in contact with each other, by one of the bolts. This bolt is of sufficient length to allow the strap to hold pipes of a wide variety of sizes ranging, by way of example, from 1-½ inch to 3 inches in diameter. Distal from these flanges, the second flange of each arcuate section has a mounting face which, in use, is disposed generally parallel to the supporting surface. A spacer is bolted to each of these mounting faces; and a bolt, also of sufficient length to allow variations in the distance between the the spacer and the contiguous flange of the arcuate section is utilized. The latter distance typically ranges from zero to one inch.

### BACKGROUND OF THE INVENTION

In many places where a conduit or pipe is installed, a gap exists between it and the supporting surface. One such place is the electrical service entrance to a building. There the hole in the meter box which receives the conduit is typically located from ½ inch to 1 inch distal from the mounting surface to which the meter box is secured. In addition, the size of the service entrance pipe itself varies widely. Most commonly, it is between 1-½ inches to 3 inches in diameter. A conduit/pipe strap which can be adjusted to compensate for differences in the spacing between the conduit or pipe and the wall to which it is secured, as well fitting conduit/pipes of various diameters, represents a long-standing need in the prior art.

### SUMMARY OF THE INVENTION

The object of this invention is to provide a strap for supporting a conduit/pipe which is sufficiently adjustable to hold it, at various distances, from the supporting surface and to so hold conduit/pipe whose diameter falls within a wide range of sizes.

The strap according to the present invention comprises four structural members and three bolts for holding them in assembled relation, the structural members and the bolts so assembled defining a support bracket which can be rigidly attached to a wall and used to clamp a pipe in position proximate with it. The bolts also allow a user to adjust the extension of the bracket in two dimensions so that pipes of various sizes, as well as pipes held at a range of distances from the mounting surface, can be clamped thereto. In the preferred embodiment, the structural members are fabricated of sheet metal. Alternately, they are molded of plastic.

The two structural members, which in the assembled support bracket are disposed in the mid-section thereof are generally mirror images of one another, each member of this pair defining an arcuate section from which first and second flanges extend radially. Disposed at the distal ends of each arcuate section, the working faces of these flanges, in the individual structural member, lie in imaginary planes extending perpendicularly to each other.

When the two curved structural members are bolted together, an arch is created, the span of the arch depending upon the spacing between contiguous first flanges on these members in the support bracket. The bolt holding these two flanges is of sufficient length to allow a wide range of pipe sizes, typically ranging from 1-½ inch to 3 inches to be clamped beneath the arch. The face of the second flange on each of the arch-defining structural members, in use, is disposed generally parallel to the mounting surface.

Bolted to each second flange is a spacer section which, in turn, is secured by fastening means to a wall or the like. The bolts holding the spacer sections to the second flanges are also of sufficient length to allow each second flange to be spaced apart from the contiguous end of the spacer section to which the second flange is attached, thereby allowing the support bracket to be used to hold pipe sections at various distances from the mounting surface. In use, the spacing between the second flange and the contiguous spacer section ranges, by way of example, from zero to one inch.

### BRIEF DESCRIPTION OF THE DRAWINGS

FIG. 1 is an exploded perspective view of the conduit/pipe support bracket according to the present invention;

FIG. 2 is an top right side perspective showing the bracket according to FIG. 1 in a typical installation, the dashed lines of the pipe and meter box being shown for illustrative purposes only and forming no part of the invention;

FIG. 3 is a top plan view of the bracket according to FIG. 1;

FIG. 4 is a side view of the bracket according to FIG. 1;

FIG. 5 is a front elevational view of the bracket according to FIG. 1;

FIG. 6 is a rear elevational view of the bracket according to FIG. 1;

FIG. 7 is an exploded view of an alternate embodiment of the bracket according to the present invention, the pipe and the mounting channel being shown in dashed lines for illustrative purposes only and forming no part of the invention;

FIG. 8 is an top right side perspective showing the bracket according to FIG. 7 in a typical installation, the dashed lines of the mounting channel being shown for illustrative purposes only and forming no part of the invention;

FIG. 9 is top plan view of the bracket according to FIG. 7; and

FIG. 9 is a side elevational view of the bracket according to FIG. 7.

### DETAILED DESCRIPTION OF THE PREFERRED EMBODIMENT

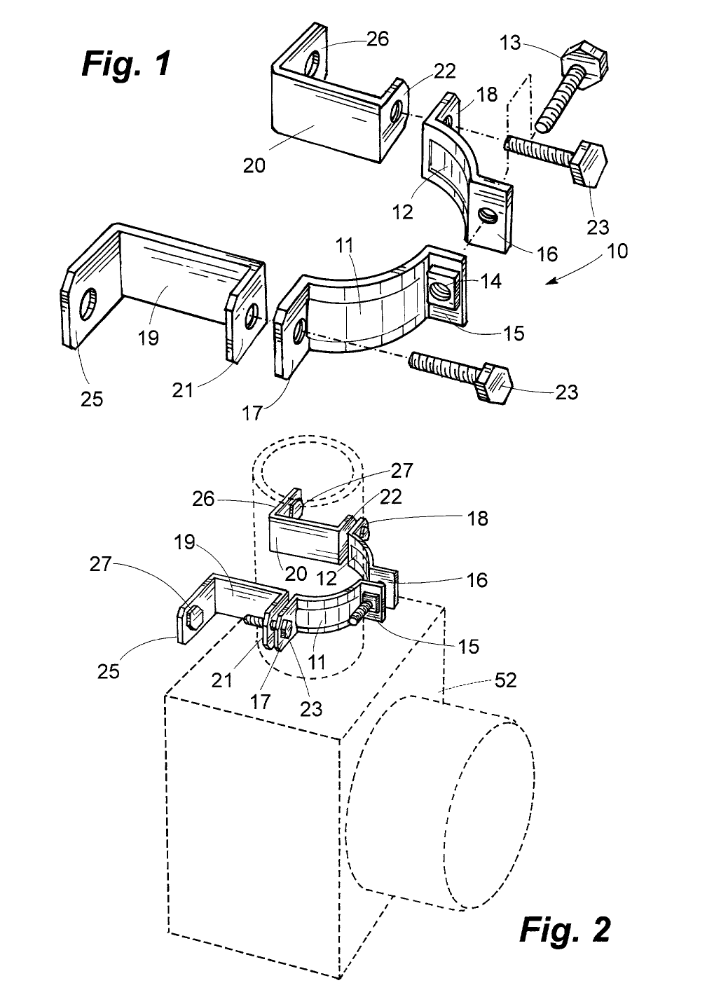

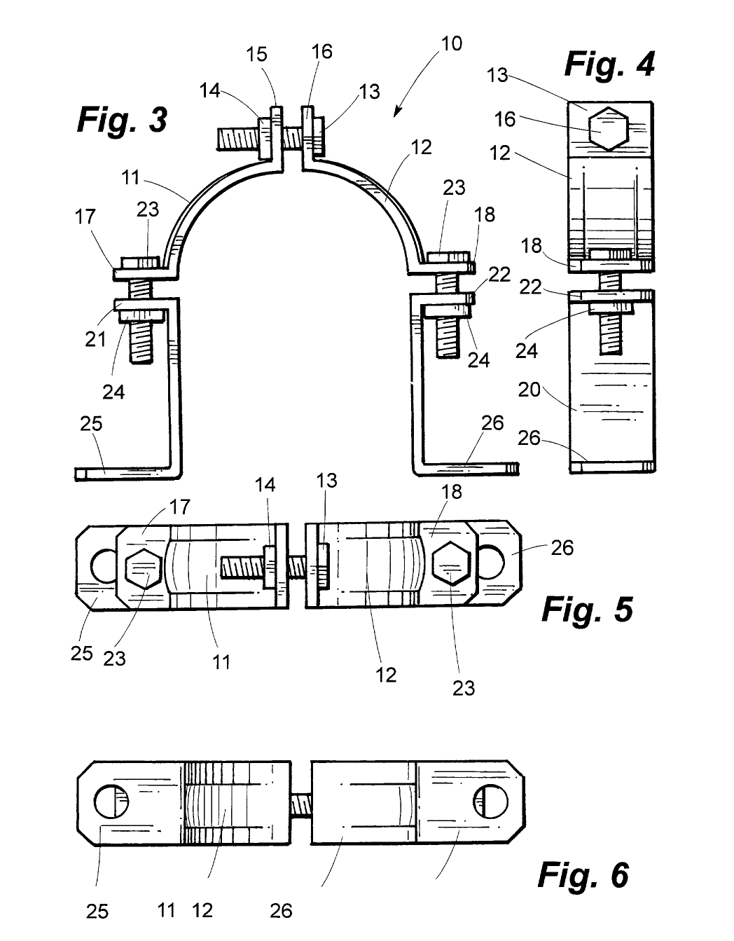

In the drawings, a support bracket for holding a conduct/pipe to a mounting surface is indicated generally by the reference numeral 10. The bracket 10 includes four structural members, which are preferably formed sheet metal sections as illustrated in FIGS. 1 through 6. In two of these structural members, arcuate sections 11, 12 terminate in first and second flanges 15, 17; 16, 18, respectively. Each flange 15, 16, 17, 18 defines a hole for receiving a bolt; bolts 13, 23 and nuts 14, 24 are employed to hold the bracket 10 in assembled relation.

In use, the bolt 13 with its nut 14 is tightened only enough to hold the arcuate sections 11, 12 against the conduct/pipe 50. For added convenience, the nut 14 is preferably permanently fastened to the first flange 15.

Distal from the first flange 15, 16, each second flange 17, 18 is paired with mating surface 21, 22, respectively, on a spacer 19, 20 and held in position with bolts 23 and their nuts 24. As in the case of the bolt 13 and nut 14, each bolt 23 and nut 24 is tightened only as much as is needed to clamp the pipe/conduit 50 to the mounting surface.

Each spacer 19, 20 include a mounting foot 25, 26 which defines a central hole for receiving mounting fasteners 27 to secure the bracket 10 to the mounting surface.

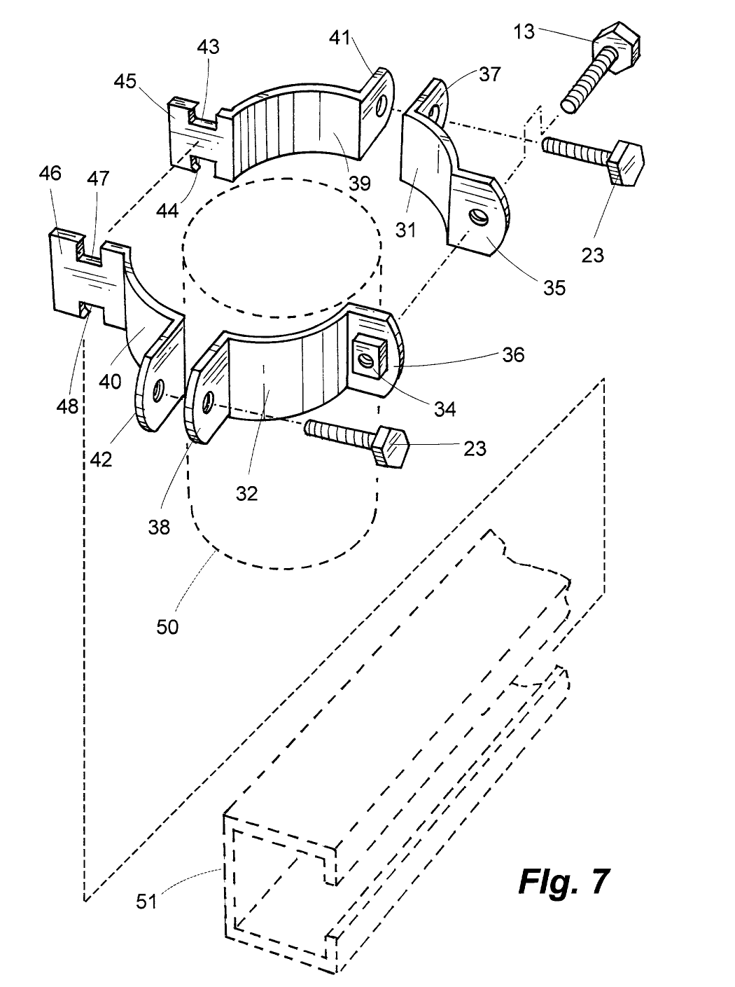

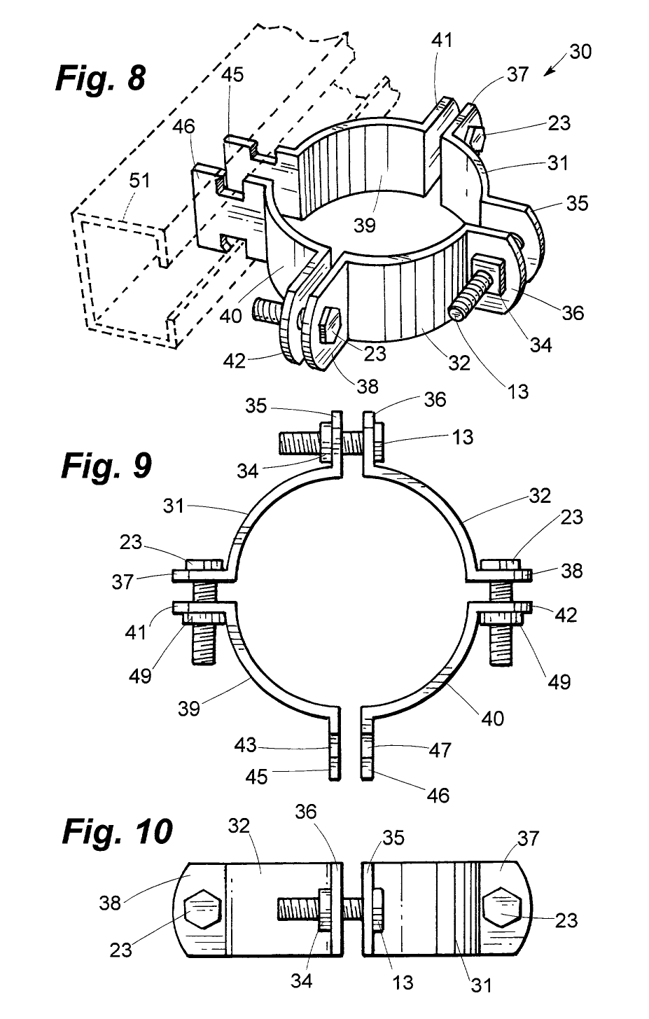

An alternate embodiment allows the adjustable support bracket 30 to be used with a holding channel 51 such as the Unistrut R (FIGS. 7 through 10). First flanges 35, 36 on structural members 31, 32 are held in assembled relation with the use of a bolt 13 and nut 34. Similarly, second flanges 37, 38 are held in position relative to mounting surfaces 41, 42 on arcuate spacers 39, 40 by bolts 23 and nuts 49 (FIG. 9). Mounting feet 45, 46 define grooves 43, 44; 47, 48, respectively, for engaging the holding channel 51 (FIG. 7).

It is understood that those skilled in the art may conceive other applications, modifications and/or changes in the invention described above. Any such applications, modifications or changes which fall within the purview of the description are intended to be illustrative and not intended to be limitative. The scope of the invention is limited only by the scope of the claims appended hereto.

It is claimed:

1. A pipe strap for holding pipes of various sizes in position relative to a mounting surface, comprising four structural members bolted together, each of at least two of the structural members defining an arcuate section, first and second flanges extending radially from distal ends of the arcuate section; working faces of the first and second flanges, in individual structural members, lying in imaginary planes which extend perpendicularly to each other; in use, arcuate sections of said two structural members defining an arch, the span of the arch depending upon spacing between contiguous first flanges on these two structural members, so that the strap can be adjusted to fit around pipe; second flanges on the arcuate sections being bolted to third and fourth structural members; and means for securing the third and fourth structural members to the mounting surface.

2. The pipe strap according to claim 1, in which the third and fourth structural members each define a plate having a pair of grooves for supporting the strap on the mounting surface.
